(19) United States
(12) Patent Application Publication
(10) Pub. No.: US 2026/0329525 A1
(43) Pub. Date: Oct. 22, 2026

(54) COMMUNICATION BETWEEN AUDIO PLUG-INS

(71) Applicant: Apple Inc., Cupertino, CA (US)

(72) Inventor: Jack P. Newman, Sunnyvale, CA (US)

(21) Appl. No.: 19/644,242

(22) Filed: Apr. 10, 2026

Related U.S. Application Data
(60) Provisional application No. 63/791,793, filed on Apr. 21, 2025.

(51) Int. Cl. G06F 3/16; G06F 3/0484

(52) U.S. Cl. CPC G06F 3/165; G06F 3/0484

(57) ABSTRACT

In one implementation, a method of displaying the value of a property of an asset is performed at a device including a display, one or more processors, and non-transitory memory. The method includes displaying a first audio plug-in window including a first value of a first property of a first audio asset. The method includes displaying a second audio plug-in window including the first value of the first property of the first audio asset. The method includes receiving first user input changing the first property of the first audio asset from the first value to a second value. The method includes, in response to receiving the first user input, displaying the first audio plug-in window including the second value of the first property of the first audio asset and displaying the second audio plug-in window including the second value of the first property of the first audio asset.

### CROSS-REFERENCE TO RELATED APPLICATIONS

This application claims priority to U.S. Provisional Patent App. No. 63/791,793, filed on Apr. 21, 2025, which is hereby incorporated by reference in its entirety.

### TECHNICAL FIELD

The present disclosure generally relates to audio plug-ins for a digital audio workstation application.

### BACKGROUND

A digital audio workstation application allows users to generate an output audio stream based on the temporal arrangement of a number of audio waveforms.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a physical setting with an electronic device surveying the physical setting.

FIGS. 2A-2N illustrate the electronic device of FIG. 1 displaying a graphical user interface (GUI) of a digital audio workstation application.

FIG. 3 is a flowchart representation of a method of displaying a value of a property of an asset in accordance with some implementations.

FIG. 4 is a block diagram of an electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying a value of a property of an asset. In various implementations, the method is performed at a device including a display, one or more processors, and non-transitory memory. In various implementations, the method includes displaying a first audio plug-in window including a first value of a first property of a first audio asset. The method includes displaying a second audio plug-in window including the first value of the first property of the first audio asset. The method includes receiving first user input changing the first property of the first audio asset from the first value to a second value. The method includes, in response to receiving the first user input, displaying the first audio plug-in window including the second value of the first property of the first audio asset and displaying the second audio plug-in window including the second value of the first property of the first audio asset.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As noted above, a digital audio workstation (DAW) application allows users to generate an output audio stream based on the temporal arrangement of a number of audio waveforms. The audio waveforms may be included as assets having various object properties and they may be combined according to various rendering properties. The DAW application allows a user to view (and change) values of those properties in various ways. For example, when the operating system executes the DAW application software to create a DAW process, the DAW process can load various audio plug-ins into the DAW process, such as an object plug-in which displays the values of properties of a particular asset or a renderer plug-in which displays values of properties used when rendering the audio waveforms into an audio file.

When a DAW process loads an audio plug-in into the DAW process, the functionality of the audio plug-in is incorporated into the DAW application and the audio plug-in can receive data from and send data to the DAW process. However, when the DAW process loads multiple audio plug-ins, each audio plug-in is isolated from the other audio plug-ins. Although a first plug-in can send data to the DAW process which can, in turn, send the data to a second audio plug-in, the types of data that can be communicated in this way are limited. In particular, the types of data are limited by the functionality of the DAW application which can only receive and send certain data types.

In order for multiple plug-ins to communicate data irrespective of the limitations of the DAW application, one or more of a suite of audio plug-ins can be loaded by the DAW process which are each configured to instruct the DAW process to load a dynamic library into the DAW process that provides an interface between the audio plug-ins and a dedicated portion of memory.

In various implementations, the suite of audio plug-ins and the dynamic library are distributed and/or installed as a single package. In various implementations, each of the suite of audio plug-ins is configured to instruct the DAW process to load the dynamic library only if it is not already loaded. In various implementations, each of the suite of audio plug-ins is configured to instruct the DAW process to load the dynamic library and, if the dynamic library is already loaded, the audio plug-in receives a reference to the already loaded instance.

As noted above, the dynamic library provides an interface between the audio plug-ins and a dedicated portion of memory. In various implementations, the portion of memory corresponds to a singleton object defined by the dynamic library. Each of the suite of audio plug-ins can, using the dynamic library, read from and write to this portion of memory. For example, a first audio plug-in can write data to the portion of memory and a second audio plug-in can read the data from the portion of memory. Accordingly, the first audio plug-in and the second audio plug-in can communicate any type of data without involvement of the DAW process or restriction by the functionality of the DAW application.

For example, when creating a spatial audio file emulating the experience of a various audio waveforms emanating from a various positions in a three-dimensional space, a first object plug-in may be associated with a first audio waveform and a first position and a second object plug-in may be associated with a second audio waveform and a second position. A renderer plug-in cannot obtain the first position and second position from the first object plug-in, the second object plug-in, or the DAW process. However, if the first object plug-in writes, using the dynamic library, the first position to the portion of memory and the second object plug-in writes, using the dynamic library, the second position to the portion of memory, the renderer plug-in can read, using the dynamic library, the first position and the second position from the portion of memory and render the first audio waveform and the second audio waveform as emanating from their respective positions to create a spatial audio file.

Similarly related to spatial audio, a head orientation plug-in could obtain real-time head orientation data of a user via a tracking device and write the head orientation data to the portion of memory managed by the dynamic library. Other plug-ins of the DAW process could retrieve, from the portion of memory, the head orientation data to apply plug-in-specific audio processing algorithms.

Broadly and unrelated to spatial audio, a loudness plug-in could calculate a loudness value of an audio input and write loudness data (including, e.g., the loudness value and an indication of the type of loudness calculation algorithm used to calculate the loudness value) to the portion of memory managed to the dynamic library. An export plug-in could retrieve, from the portion of memory, the loudness data and use this data to write metadata in a dedicated section of an audio filed created by the export plug-in.

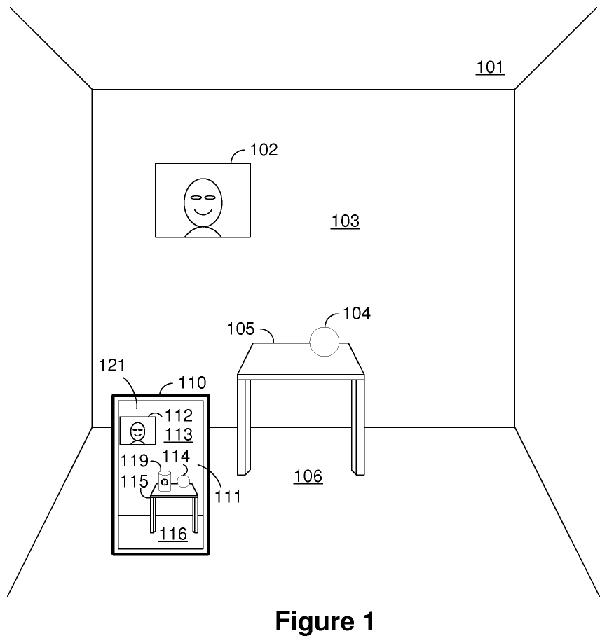

FIG. 1 illustrates a physical environment 101 with an electronic device 110 surveying the physical environment 101. The physical environment 101 includes a picture 102 hanging on a wall 103, a table 105 on a floor 106, and a ball 104 on the table 105.

The electronic device 110 displays, on a display, an image of an XR environment 121 which includes a representation of the physical environment 111 and a representation of a virtual object 119. In various implementations, the representation of the physical environment 111 is generated based on an image of the physical environment 101 captured with one or more cameras of the electronic device 110 having a field-of-view directed toward the physical environment 101. Suitable cameras include scene cameras, event cameras, depth cameras, and so forth. Accordingly, the representation of the physical environment 111 includes a representation of the picture 112 hanging on a representation of the wall 113, a representation of the table 115 on a representation of the floor 116, and a representation of the ball 114 on the representation of the table 115.

In addition to the representations of real objects of the physical environment 101, the image of the XR environment 121 includes a representation of the virtual object 119. The visual appearance of virtual object 119 is defined by software on the electronic device 110. The electronic device 110 presents virtual object 119 as resting on the top surface of the representation of the table 115 by accounting for the position and orientation of electronic device 110 relative to table 105.

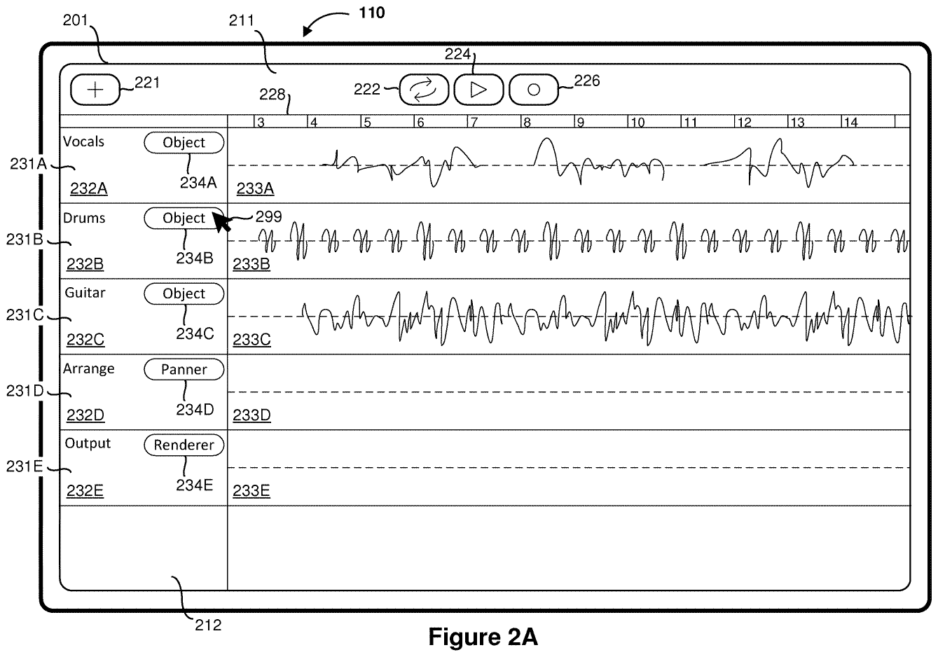

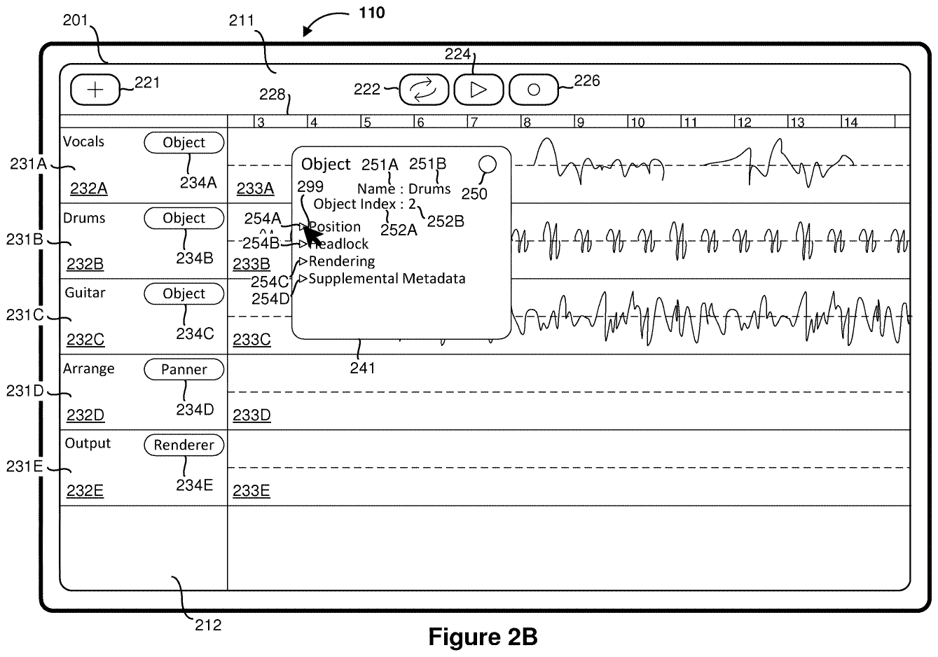

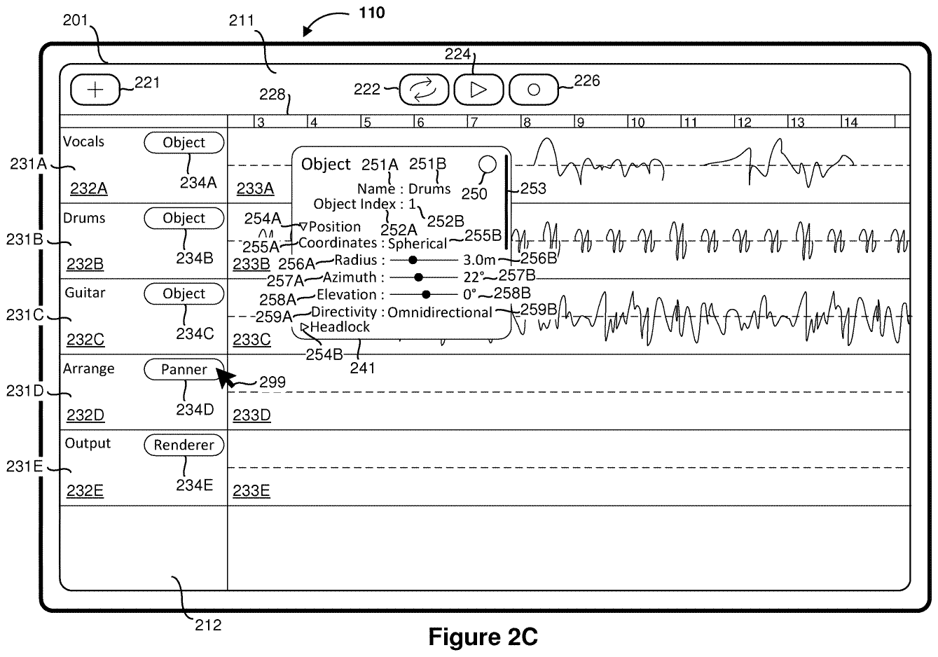

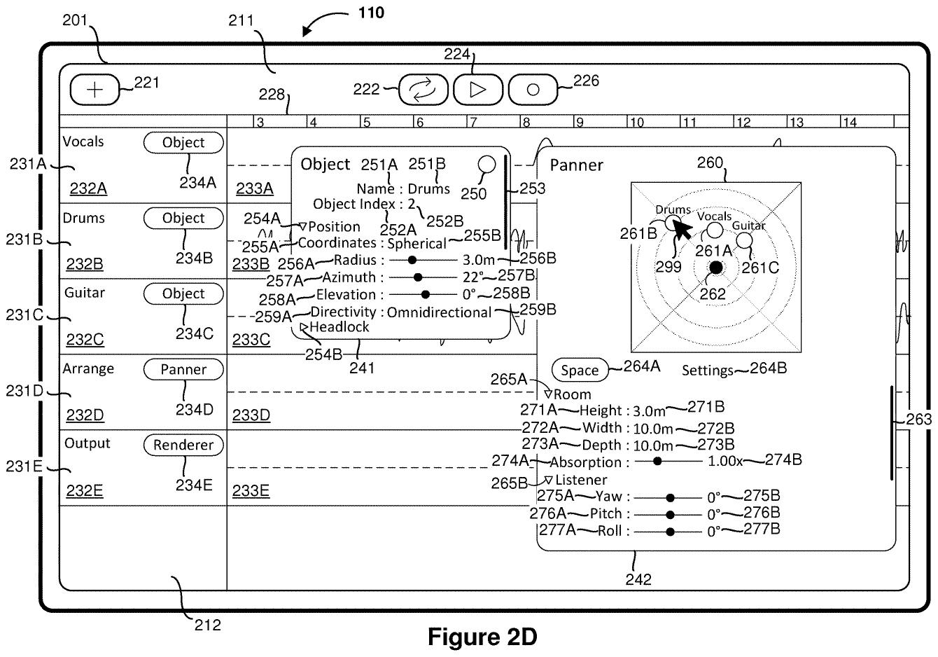

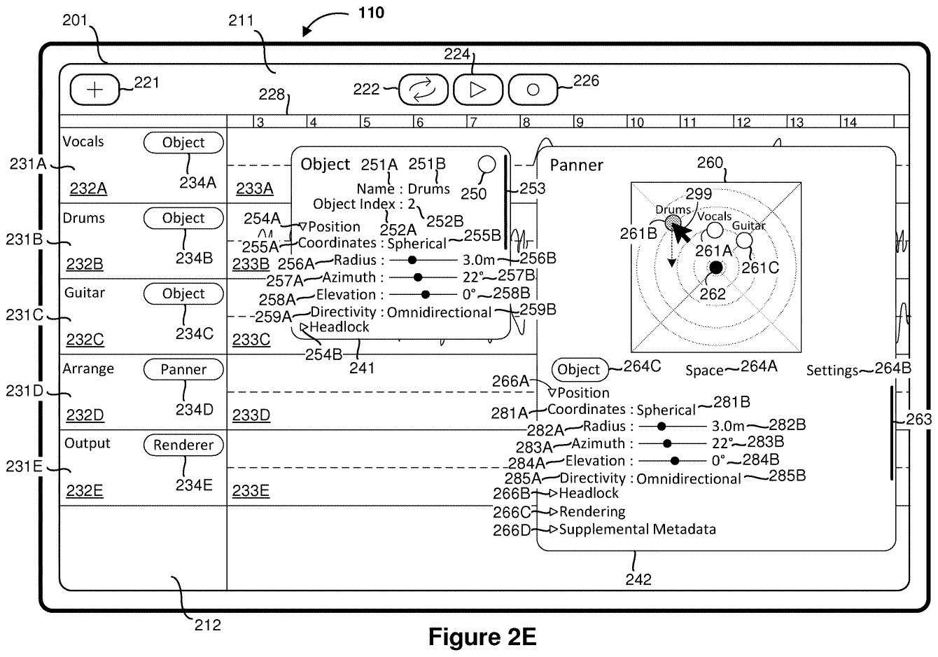

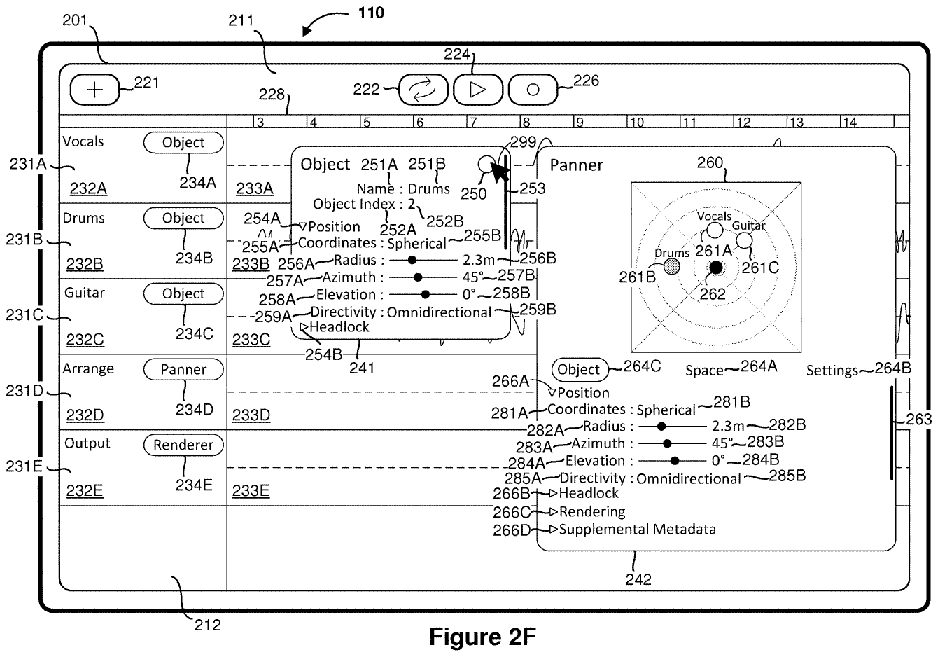

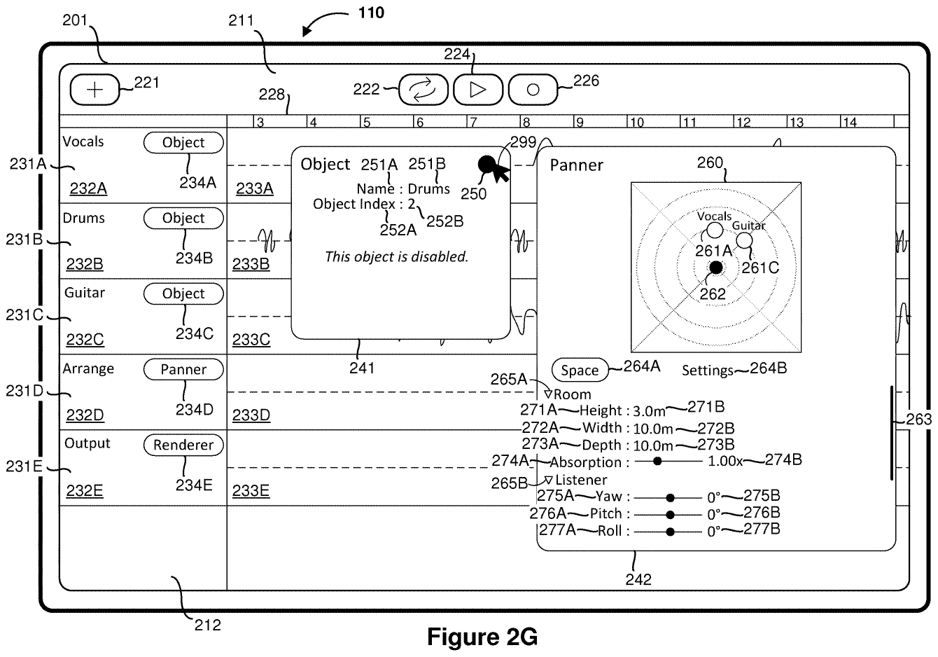

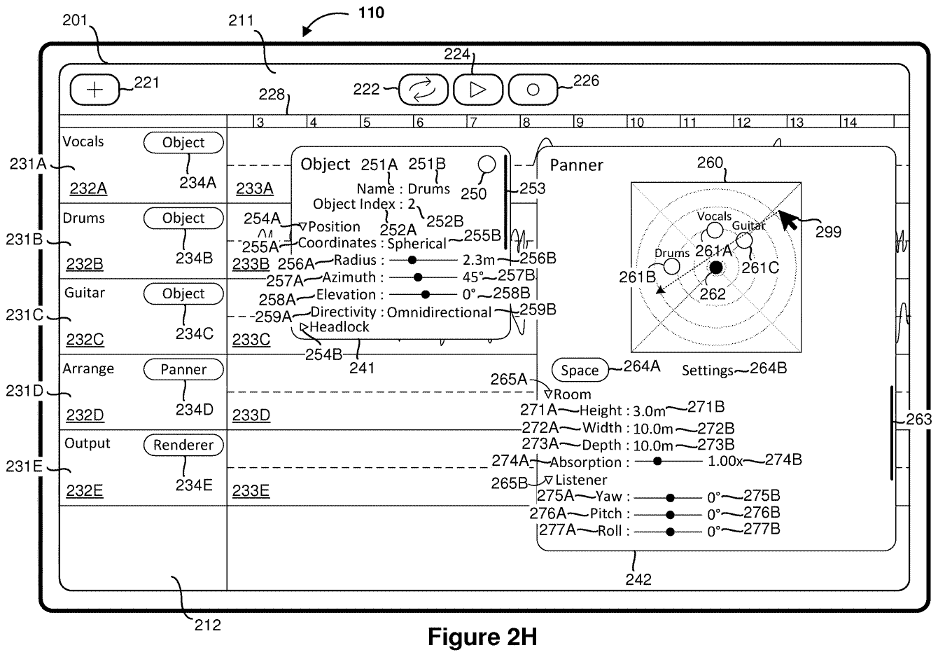

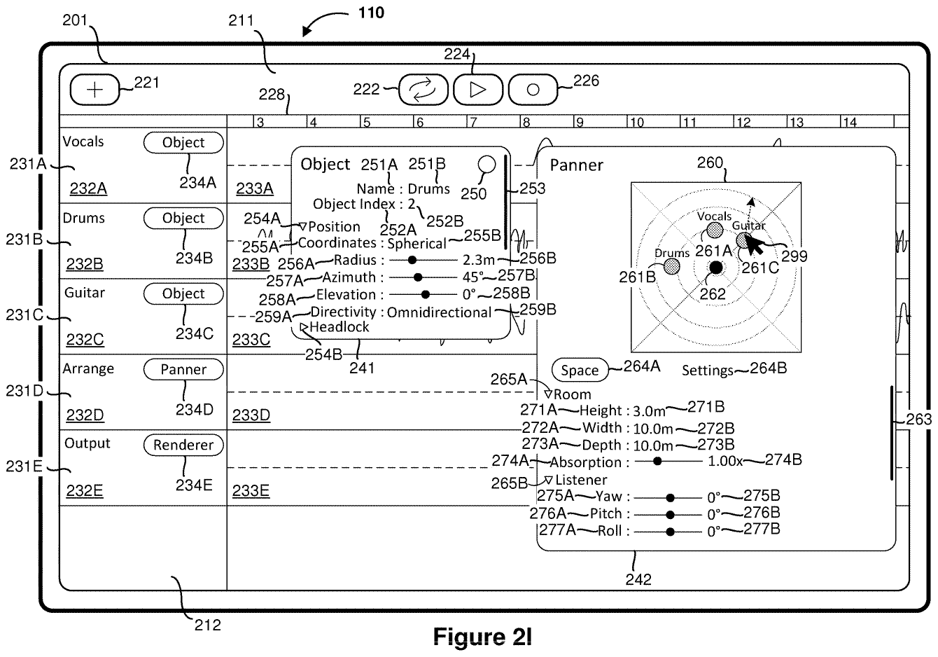

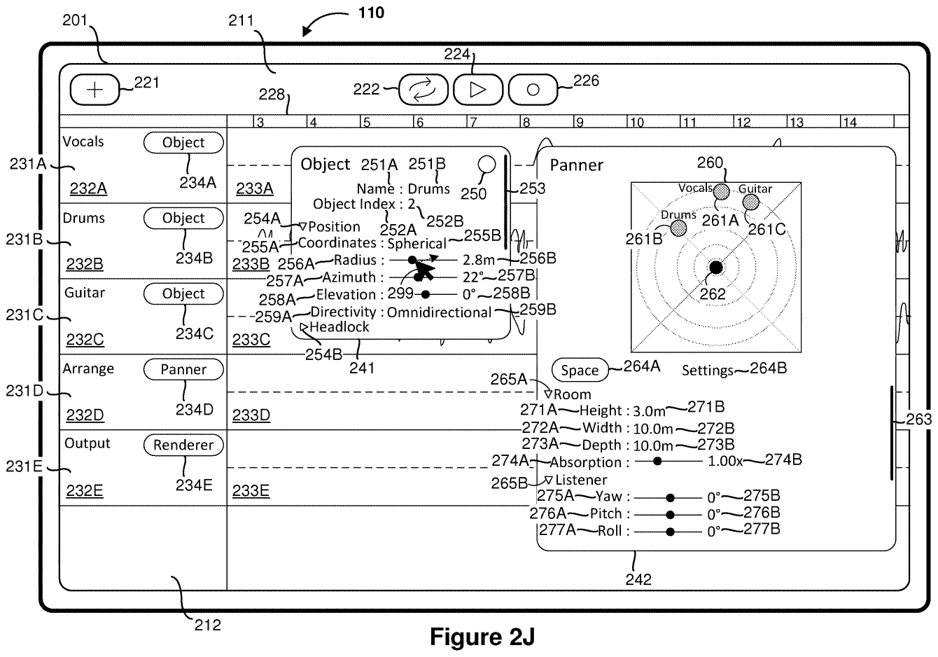

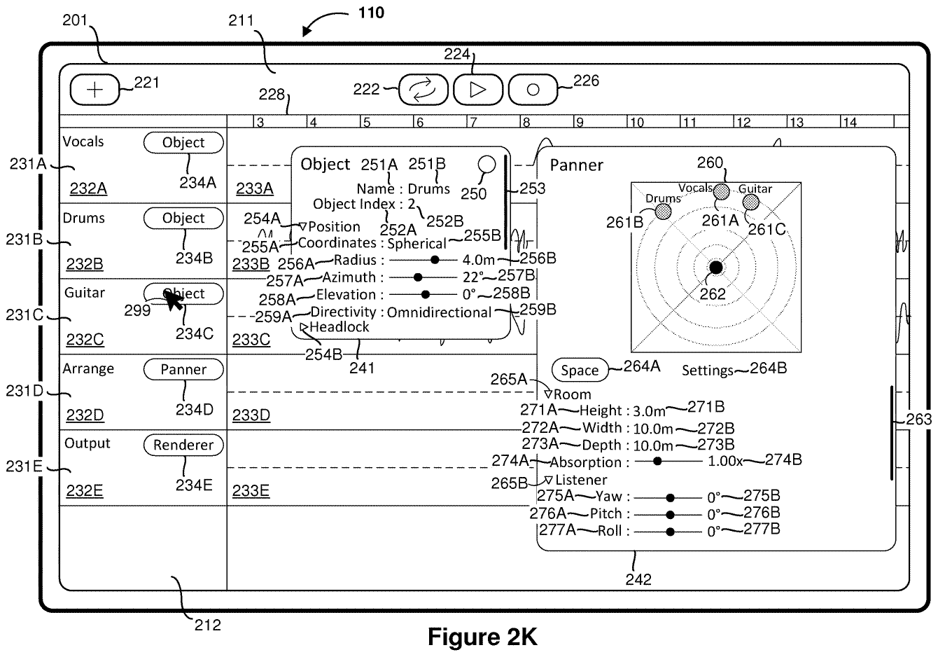

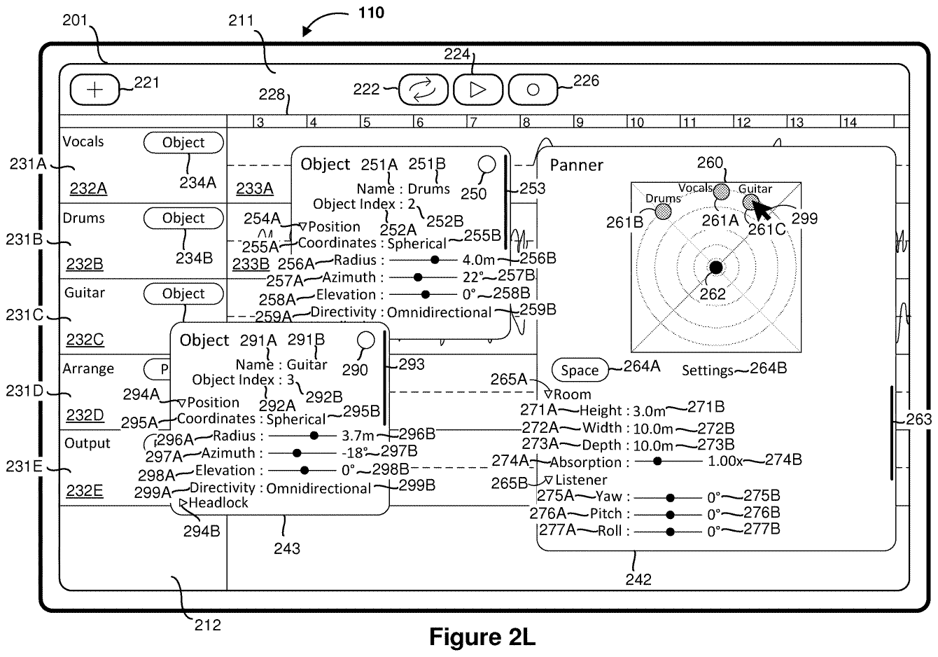

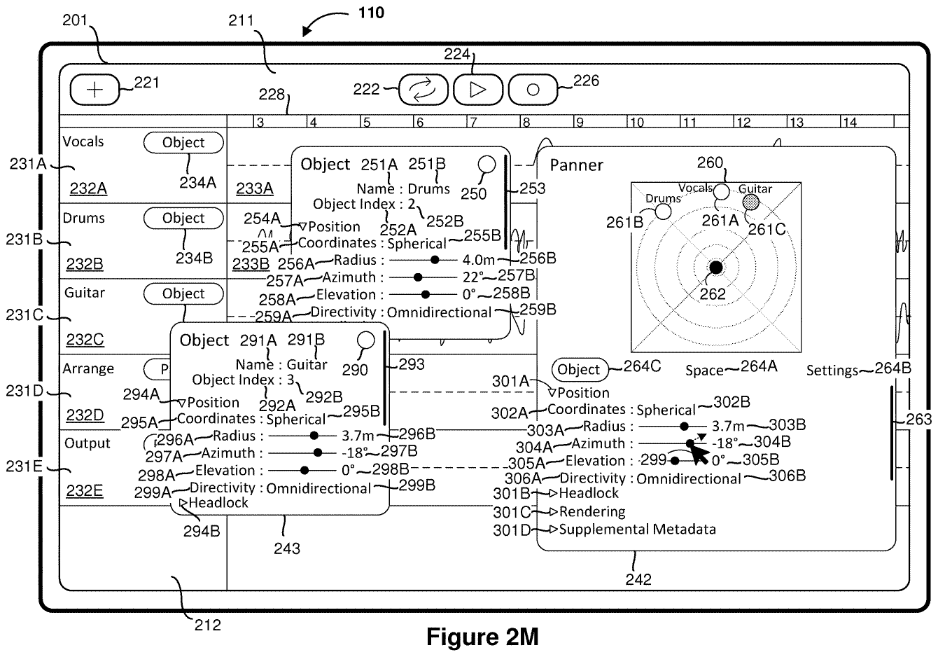

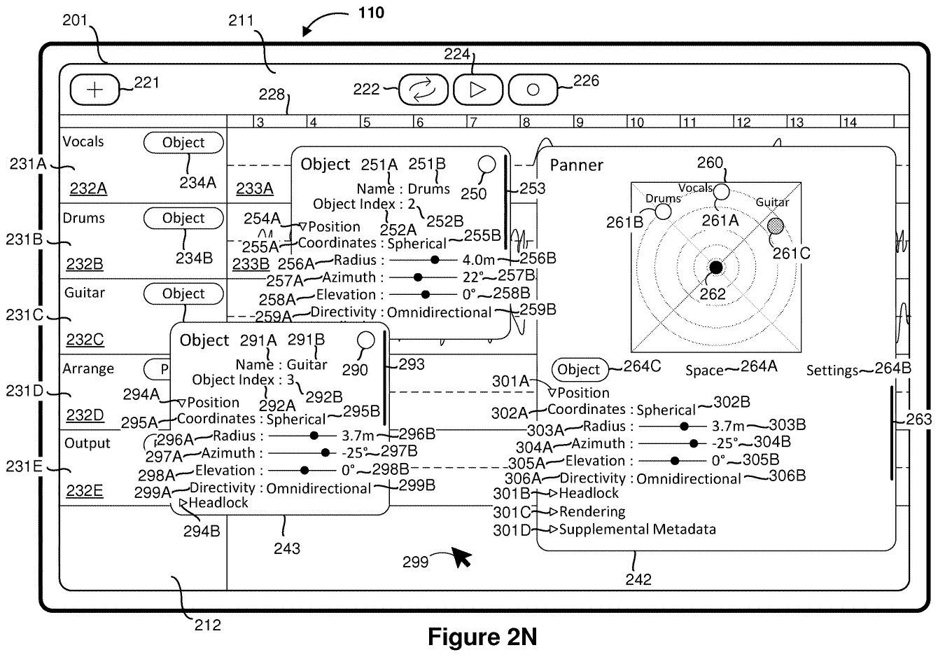

FIG. 2A illustrates the electronic device 110 displaying a graphical user interface (GUI) 201 of a digital audio workstation (DAW) application. In particular, the GUI 201 is defined by a DAW process created by an operating system by executing DAW software of the DAW application. In various implementations, application software of the electronic device 110 or a different electronic device is executed to present an audio stream generated via the GUI 201. In various implementations, the GUI 201 can be used to compose an audio stream and the electronic device 110 (or a different electronic device) executes software to play the audio stream via one or more speakers.

The GUI 201 includes a toolbar region 211 and an assets region 212. The toolbar region 211 includes various affordances for starting a new project, opening a project, or playing assets of a project. Although certain affordances are illustrated in FIGS. 2A-2N, in various implementations, the toolbar region includes more or fewer affordances. In FIGS. 2A-2N, the toolbar region 221 includes an add asset affordance 221 which, when selected, imports a new asset into the currently open project. In FIGS. 2A-2N, the toolbar region 211 includes a play affordance 224 which, when selected, plays audio corresponding to one or more assets of the currently opened project. In FIGS. 2A-2N, the toolbar region 211 includes a loop affordance 222 which, when selected toggles between a looped playback mode or an unlooped playback mode. While in the looped playback mode, selection of the play affordance 224 causes audio corresponding to one or more assets of the currently opened project to be played on a loop. While in the unlooped playback mode, selection of the play affordance 224 causes audio corresponding to one or more assets of the currently opened project to be played once. In FIGS. 2A-2N, the toolbar region 211 includes a record affordance 226 which, when selected, records audio to be added to one or more assets of the currently opened project. In FIGS. 2A-2N, the toolbar region 211 includes a time bar 228 which provides a scale for the waveforms of audio of one or more of the assets of the currently opened project.

The assets region 212 includes representations of the assets of the project. Each asset is represented with a configuration region and a waveform region. For example, the assets region 212 includes a first asset representation 231A including a first configuration region 232A and a first waveform region 233A, a second asset representation 231B including a second configuration region 232B and a second waveform region 233B, a third asset representation 231C including a third configuration region 232C and a third waveform region 233C, a fourth asset representation 231D including a fourth configuration region 232D and a fourth waveform region 233D, and a fifth asset representation 231E including a fifth configuration region 232E and a fifth waveform region 233E.

The first asset representation 231A represents a first asset associated with audio of a vocal track. Thus, the first configuration region 232A includes the text “Vocals” identifying the first asset and a first object plug-in affordance 234A which, when selected, opens a first object plug-in window. The first waveform region 233A includes a graphical representation of the waveform of the audio of the vocal track. The second asset representation 231B represents a second asset associated with audio of a drum track. Thus, the second configuration region 232B includes the text “Drums” identifying the second asset and a second object plug-in affordance 234B which, when selected, opens a second object plug-in window. The second waveform region 233B includes a graphical representation of the waveform of the audio of the drum track. The third asset representation 231C represents a third asset associated with audio of a guitar track. Thus, the third configuration region 232C includes the text “Guitar” identifying the third asset and a third object plug-in affordance 234C which, when selected, opens a third object plug-in window. The third waveform region 233C includes a graphical representation of the waveform of the audio of the guitar track.

The fourth asset representation 231D represents a fourth asset associated with a spatial arrangement of the first asset, the second asset, and the third asset. Thus, the fourth configuration region 232D includes the text “Arrange” identifying the fourth asset and a panner plug-in affordance 234D which, when selected, opens a panner plug-in window. Because the fourth asset does not require audio data as an input, the fourth waveform region 233D is blank.

The fifth asset representation 231E represents a fifth asset associated with rendering parameters for generating an audio stream based on the audio of the first asset, the second asset, and the third asset (and, in various implementations, other data regarding the first asset, second asset, and third assets, such as their positions). Thus, the fifth configuration region 232E includes the text “Output” identifying the fifth asset and a renderer plug-in affordance 234E which, when selected, opens a renderer plug-in window. Because the fifth asset receives as input the audio data associated with the object assets and does not require additional audio data input, the fifth waveform region 233E is blank.

The GUI 201 further includes a cursor 299 which, in FIG. 2A, is displayed over the second object plug-in affordance 234B.

FIG. 2B illustrates the GUI 201 of FIG. 2A in response to detecting activation of the second object plug-in affordance 234B. For example, in various implementations, the electronic device 110 detects a click of a mouse button while the cursor 299 is displayed over the second object plug-in affordance 234B. In various implementations, the electronic device 110 detects activation of a user interface element in various ways. For example, in various implementations, the electronic device 110 detects a click of a mouse button while the cursor 299 is displayed over the user interface element. As another example, the electronic device 110 detects a press on a trackpad while the cursor 299 is displayed over the user interface element. As another example, in various implementations, the device detects a finger touching the electronic device 110 at the location the user interface element is displayed. As another example, in various implementations, the electronic device 110 detects a hand gesture while a user is looking at the user interface element. As another example, in various implementations, the electronic device 110 detects activation of a switch device while focus is directed to the user interface element.

In response to detecting activation of the second object plug-in affordance 234B, the GUI 201 includes a second object plug-in window 241. The second object plug-in window 241 is defined by an object plug-in loaded into the DAW process. The second object plug-in window 241 includes the text “Object” identifying the object plug-in as the type of plug-in providing the data displayed within the second object plug-in window 241. Although, in various implementations, the object plug-in provides, to the GUI 201, the data displayed within the second object plug-in window 241, the data itself is stored in a portion of memory managed by a dynamic library loaded into the DAW process.

The second object plug-in window 241 includes representations of properties of the second asset and representations of values of those properties. For example, the second object plug-in includes a textual representation of a name property of the second asset 251A (e.g., the text “Name”) and a textual representation of a value of the name property of the second asset 251B (e.g., the text “Drums”). The second object plug-in includes a textual representation of an index property of the second asset 252A (e.g., the text “Object Index”) and a textual representation of a value of the index property of the second asset 252B (e.g., the text “2”). The second object plug-in window 241 includes a graphical representation of an activation property of the second asset 250. The value of the activation of the second asset is graphically indicated by a color of the graphical representation of the activation property of the second asset 250 which, for example, is white when the second asset is active and black when the second asset is inactive.

The second object plug-in window 241 indicates additional properties of the second asset (and their values) in selectable drop-down menus. For example, the second object plug-in window 241 includes a position drop-down menu 254A, a headlock drop-down menu 254B, a rendering drop-down menu 254C, and a supplemental drop-down menu 254D.

In FIG. 2B, the cursor 299 is displayed over the position drop-down menu 254A.

FIG. 2C illustrates the GUI 201 of FIG. 2B in response to detecting activation of the position drop-down menu 254A. In response to detecting activation of the position drop-down menu 254A, the position drop-down menu 254A is expanded within the second object plug-in window 241 to display representations of positional properties of the second asset and corresponding representations of values of the positional properties of the second asset. In particular, the second object plug-in window 241 includes an object plug-in textual representation of a coordinates property of the second asset 255A (e.g., the text “Coordinates”) and an object plug-in textual representation of a value of the coordinates property of the second asset 255B (e.g., the text “Spherical). The second object plug-in window 241 includes an object plug-in textual representation of a radius property of the second asset 256A (e.g., the text “Radius”) and an object plug-in textual representation of a value of the radius property of the second asset 256B (e.g., the text “3.0 m”). Between the object plug-in textual representation of the radius property of the second asset 256A and the object plug-in textual representation of the value of the radius property of the second asset 256B is an object plug-in graphical representation of the value of the radius property of the second asset in the form of a slider. The second object plug-in window 241 includes an object plug-in textual representation of an azimuth property of the second asset 257A (e.g., the text “Azimuth”) and an object plug-in textual representation of a value of the azimuth property of the second asset 257B (e.g., the text “22°”). Between the object plug-in textual representation of the azimuth property of the second asset 257A and the object plug-in textual representation of the value of the azimuth property of the second asset 257B is an object plug-in graphical representation of the value of the azimuth property of the second asset in the form of a slider. The second object plug-in window 241 includes an object plug-in textual representation of an elevation property of the second asset 258A (e.g., the text “Elevation”) and an object plug-in textual representation of a value of the elevation property of the second asset 258B (e.g., the text “0°”). Between the object plug-in textual representation of the elevation property of the second asset 258A and the object plug-in textual representation of the value of the elevation property of the second asset 258B is an object plug-in graphical representation of the value of the elevation property of the second asset in the form of a slider. The second object plug-in window 241 includes an object plug-in textual representation of a directivity property of the second asset 259A (e.g., the text “Directivity”) and an object plug-in textual representation of a value of the directivity property of the second asset 259B (e.g., the text “Omnidirectional”).

In FIG. 2C, the second object plug-in window 241 includes the headlock drop-down menu 254B, but not the rendering drop-down menu 254C or the supplemental drop-down menu 254D. Instead, the second object plug-in window includes a scroll bar 253 which a user can manipulate to show the other drop-down menus.

In FIG. 2C, the cursor 299 is displayed over the panner plug-in affordance 234D.

FIG. 2D illustrates the GUI 201 of FIG. 2C in response to detecting activation of the panner plug-in affordance 234D. In response to detecting activation of the panner plug-in affordance 234D, the GUI 201 includes a panner plug-in window 242. The panner plug-in window 242 is defined by a panner plug-in loaded into the DAW process. The panner plug-in window 242 includes a spatial diagram 260 indicating relative locations of the first asset, the second asset, and the third asset in a scene by the position of a first asset representation 261A, the position of a second asset representation 261B, and the position of a third asset representation 261C in the spatial diagram 260 with respect to a listener representation 262. For example, the position of the second asset representation 261B in the spatial diagram 260 is defined by the value of the radius property of the second asset, the value of the azimuth property of the second asset, and the value of the elevation property of the second asset.

The panner plug-in window 242 includes a space affordance 264A which, when selected, causes the panner plug-in window 242 to display representations of properties of the scene and representations of values of those properties. The panner plug-in window 242 includes the text “Panner” identifying the panner plug-in as the type of plug-in providing the data displayed within the panner plug-in window 242. Although, in various implementations, the panner plug-in provides, to the GUI 201, the data displayed within the panner plug-in window 242, the data itself is stored in the portion of memory managed by the dynamic library loaded into the DAW process. Thus, as described below, multiple plug-ins can provide the same data to different windows of the GUI 201 as, ultimately, it is derived from the same source (e.g., the portion of memory managed by the dynamic library).

The panner plug-in window 242 includes a settings affordance 264B which, when selected, causes the panner plug-in window 242 to display representations of setting properties and representations of values of those properties. In FIG. 2D, the space affordance 264A is selected and representations of properties of the scene are displayed in a room drop-down menu 265A and a listener drop-down menu 265B. The panner plug-in window 242 includes a textual representation of a height property of the scene 271A (e.g., the text “Height”) and a textual representation of a value of the height property of the scene 271B (e.g., the text “3.0 m”). The panner plug-in window 242 includes a textual representation of a width property of the scene 272A (e.g., the text “Width”) and a textual representation of a value of the width property of the scene 272B (e.g., the text “10.0 m”). The panner plug-in window 242 includes a textual representation of a depth property of the scene 273A (e.g., the text “Depth”) and a textual representation of a value of the depth property of the scene 273B (e.g., the text “10.0m ”). The panner plug-in window 242 includes a textual representation of an absorption property of the scene 274A (e.g., the text “Absorption”) and a textual representation of a value of the absorption property of the scene 274B (e.g., the text “1.00 x”). Between the textual representation of the absorption property of the scene 274A and the textual representation of the value of the absorption property of the scene 274B is a graphical representation of the value of the absorption property of the scene in the form of a slider.

The panner plug-in window 242 includes a textual representation of a yaw property of a listener of the scene 275A (e.g., the text “Yaw”) and a textual representation of a value of the yaw property of the listener of the scene 275B (e.g., the text “0°”). Between the textual representation of the yaw property of the listener of the scene 275A and the textual representation of the value of the yaw property of the listener of the scene 275B is a graphical representation of the value of the yaw property of the listener of the scene in the form of a slider. The panner plug-in window 242 includes a textual representation of a pitch property of a listener of the scene 276A (e.g., the text “Pitch”) and a textual representation of a value of the pitch property of the listener of the scene 276B (e.g., the text “0°”). Between the textual representation of the pitch property of the listener of the scene 276A and the textual representation of the value of the pitch property of the listener of the scene 276B is a graphical representation of the value of the pitch property of the listener of the scene in the form of a slider. The panner plug-in window 242 includes a textual representation of a roll property of a listener of the scene 277A (e.g., the text “Roll”) and a textual representation of a value of the roll property of the listener of the scene 277B (e.g., the text “0°”). Between the textual representation of the roll property of the listener of the scene 277A and the textual representation of the value of the roll property of the listener of the scene 277B is a graphical representation of the value of the roll property of the listener of the scene in the form of a slider.

In FIG. 2D, the cursor 299 is displayed over the second asset representation 261B in the spatial diagram 260.

FIG. 2E illustrates the GUI 201 of FIG. 2D in response to detecting activation of the second asset representation 261B. In response to detecting activation of the second asset representation 261B, the second asset representation 261B is displayed in a different manner (e.g., a different color) to indicate that the second asset is selected. Because the second asset is selected, the panner plug-in window 242 includes an object affordance 264C which, when selected, cause the panner plug-in window 242 to display representations of properties of the selected asset and representations of values of those properties.

In FIG. 2E, the object affordance 264C is selected and the panner plug-in window 242 includes representations of properties of the second asset and representations of the values of those properties organized under a position drop-down menu 266A, a headlock drop-down menu 266B, a rendering drop-down menu 266C, and a supplemental drop-down menu 266D.

In particular, within the position drop-down menu 266A, the panner plug-in window 242 includes a panner plug-in textual representation of the coordinates property of the second asset 281A (e.g., the text “Coordinates”) and a panner plug-in textual representation of the value of the coordinates property of the second asset 281B (e.g., the text “Spherical). The panner plug-in window 242 includes a panner plug-in textual representation of the radius property of the second asset 282A (e.g., the text “Radius”) and a panner plug-in textual representation of the value of the radius property of the second asset 282B (e.g., the text “3.0 m”). Between the panner plug-in textual representation of the radius property of the second asset 282A and the panner plug-in textual representation of the value of the radius property of the second asset 282B is a panner plug-in graphical representation of the value of the radius property of the second asset in the form of a slider. The panner plug-in window 242 includes a panner plug-in textual representation of the azimuth property of the second asset 283A (e.g., the text “Azimuth”) and a panner plug-in textual representation of the value of the azimuth property of the second asset 283B (e.g., the text “22°”). Between the panner plug-in textual representation of the azimuth property of the second asset 283A and the panner plug-in textual representation of the value of the azimuth property of the second asset 283B is a panner plug-in graphical representation of the value of the azimuth property of the second asset in the form of a slider. The panner plug-in window 242 includes a panner plug-in textual representation of the elevation property of the second asset 284A (e.g., the text “Elevation”) and a panner plug-in textual representation of the value of the elevation property of the second asset 284B (e.g., the text “0°”). Between the panner plug-in textual representation of the elevation property of the second asset 284A and the panner plug-in textual representation of the value of the elevation property of the second asset 284B is a panner plug-in graphical representation of the value of the elevation property of the second asset in the form of a slider. The panner plug-in window 242 includes a panner plug-in textual representation of the directivity property of the second asset 285A (e.g., the text “Directivity”) and a panner plug-in textual representation of the value of the directivity property of the second asset 285B (e.g., the text “Omnidirectional”).

As suggested above, the values of the properties of the second asset are stored in the portion of memory, managed by the dynamic library, that is accessible to both the object plug-in which defines display of the second object plug-in window 241 and the panner plug-in which defines display of the panner plug-in window 242. Thus, both the second object plug-in window 241 and the panner plug-in window 242 display the same values for the properties of the second asset. For example, the object plug-in textual representation of the azimuth property of the second asset 257B is the same as the panner plug-in textual representation of the azimuth property of the second asset 283B.

Further, when the value of a property is changed, the textual representation in the second object plug-in window 241 and the textual representation in the panner plug-in window 242 are similarly updated. In various implementations, the value of a property can be changed through interaction with the second object plug-in window 241 or the panner plug-in window 242.

In FIG. 2E, the cursor 299 is displayed over the second asset representation 261B of the spatial diagram 260 in the panner plug-in window 242.

FIG. 2F illustrates the GUI 201 of FIG. 2E in response to a detecting a user input dragging the second asset representation 261B from a first location to a second location of the spatial diagram 260. In response to detecting the user input, the second asset representation 261B is moved from the first location to the second location of the spatial diagram 260. Further, in response to the user input, the value of the radius property of the second asset and the value of the azimuth property of the second asset are changed based on the second location. Thus, the panner plug-in textual representation of the radius property of the second asset 282B is changed (e.g., to the text “2.3 m”). Similarly, the object plug-in textual representation of the radius property of the second asset 256B is changed (e.g., to the text “2.3 m”). The corresponding graphical representations of the value of the radius property of the second asset are similarly changed. Likewise, the panner plug-in textual representation of the azimuth property of the second asset 283B and the object plug-in textual representation of the azimuth property of the second asset 257B is changed (e.g., to the text “45°). The corresponding graphical representations of the value of the azimuth property of the second asset are similarly changed.

In FIG. 2F, the cursor 299 is displayed over the graphical representation of the activation property of the second asset 250.

FIG. 2G illustrates the GUI 201 of FIG. 2F in response to detecting activation of the graphical representation of the activation property of the second asset 250. In response to detecting activation of the graphical representation of the second asset 250, the activation property of the second asset changes from “active” to “inactive” (or from “enabled” to “disabled”). The value of the activation property of the second asset is stored in the portion of memory managed by the dynamic library. Thus, in the second object plug-in window 241, the graphical representation of the activation property of the second asset 250 is changed from white to black and certain representations of properties of the second asset and representations of their values are replaced with a textual representation of the inactive state of the second asset. Similarly, in the panner plug-in window 242, the second asset representation 261B is removed from the spatial diagram 260. Further, the object affordance 264C is removed and the space affordance 264A is selected.

Although not shown, in FIG. 2G, in response to the value of the activation property being changed to “inactive” in the portion of memory managed by the dynamic library, a renderer plug-in would not include the associated audio waveform in the rendering output. Thus, a user could control which audio assets are included in the rendering output of the renderer plug-in solely by interaction with object plug-in windows.

In FIG. 2G, the cursor 299 is displayed over the graphical representation of the activation property of the second asset 250.

FIG. 2H illustrates the GUI 201 of FIG. 2G in response to detecting activation of the graphical representation of the activation property of the second asset 250. In response to detecting activation of the graphical representation of the second asset 250, the activation property of the second asset changes from “inactive” to “active” (or from “disabled” to “enabled”). Thus, in the second object plug-in window 241, the graphical representation of the activation property of the second asset 250 is changed from black to white and certain representations of properties of the second asset and representations of their values are once again displayed. Similarly, in the panner plug-in window 242, the second asset representation 261B is once again displayed in the spatial diagram 260, however the second asset representation 261B is not selected and the space affordance 264A remains selected.

In FIG. 2H, the cursor 299 is displayed over spatial diagram 260.

FIG. 2I illustrates the GUI 201 of FIG. 2H in response to detecting a user input selecting the first asset representation 261A, the second asset representation 261B, and the third asset representation 261C. For example, in various implementations, the user input is a dragging motion within the spatial diagram 260 that defines a rectangle encompassing the asset representations. In response to detecting the user input, the first asset representation 261A, the second asset representation 261B, and the third asset representations 261C are simultaneously selected (and displayed in gray). Because no single object is selected, the space affordance 264A remains selected.

In various implementations, rather than the space affordance 264A remaining selected, in response to selection of multiple objects, the object affordance 264C is selected and the panner plug-in window 242 includes representations of properties of the selected assets and representations of values of those properties. When the values of a particular property are the same for each of the selected assets (e.g., the elevation is 0°), the shared value is displayed as the representation of the value of the particular property. However, when the values of a particular property are different for different selected assets, this can be indicated by displaying “multiple” or greying out the representation of the value of the particular property. In various implementations, interaction with the representation of the value of the particular property changes the value of the particular property for each of the selected assets to an indicated value (which, as noted above, would be displayed as the representation of the value of the particular property).

In FIG. 2I, the cursor 299 is displayed over the third asset representation 261C.

FIG. 2J illustrates the GUI 201 of FIG. 2I in response to detecting a user input moving the first asset representation 261A, the second asset representation 261B, and the third asset representation 261C in the spatial diagram 260. In response to detecting the user input, the first asset representation 261A, the second asset representation 261B, and the third asset representation 261C are moved to new locations in the spatial diagram 260. Further, the value of the radius property and the value of the azimuth property of each of the first asset, second asset, and third asset are changed. Because the changed values are written by the panner plug-in, using the dynamic library, to the portion of memory and the object plug-in, using the dynamic library, reads the portion of memory to determine the values of the properties, in the second object plug-in window 241 the object plug-in textual representation of the radius property of the second asset 256B is changed (e.g., to the text “2.8 m”) and the object plug-in textual representation of the azimuth property of the second asset 257B is changed (e.g., to the text “22°”). The corresponding graphical representations in the second object plug-in window 241 are similarly changed.

In FIG. 2J, the cursor 299 is displayed over the object plug-in graphical representation of the radius property of the second asset.

FIG. 2K illustrates the GUI 201 of FIG. 2J in response to detecting a user input changing the value of the radius property of the second asset. In various implementations, the user input includes dragging an element of the slider of the object plug-in graphical representation of the radius property of the second asset from a first location to a second location. In various implementations, the user input includes activating the object plug-in textual representation of the radius property of the second asset 256B and inputting a new value.

In response to detecting the user input, the value of the radius property of the second asset is changed and the object plug-in textual representation of the value of the radius property of the second asset 256B is changed (e.g., to “4.0 m”). Similarly, the object plug-in graphical representation of the radius property of the second asset is changed. Because the changed values are written by the object plug-in, using the dynamic library, to the portion of memory and the panner plug-in, using the dynamic library, reads the portion of memory to determine the values of the properties, in the panner plug-in window 242, the second asset representation 261B in the spatial diagram 260 is moved to a new location within the spatial diagram 260.

In FIG. 2K, the cursor is displayed over the third object plug-in affordance 234C.

FIG. 2L illustrates the GUI 201 of FIG. 2K in response to detecting activation of the third object plug-in affordance 234C. In response to detecting activation of the third object plug-in affordance 234C, the GUI 201 includes a third object plug-in window 243. The third object plug-in window 243 includes representations of properties of the third asset and representations of values of those properties in a substantially similar manner as the second object plug-in window 241 includes representations of properties of the second asset and representations of values of those properties.

The third object plug-in window 243 includes a textual representation of a name property of the third asset 291A (e.g., the text “Name”) and a textual representation of a value of the name property of the third asset 291B (e.g., the text “Guitar”). The third object plug-in window 243 includes a textual representation of an index property of the third asset 292A (e.g., the text “Object Index”) and a textual representation of a value of the index property of the third asset 292B (e.g., the text “3”). The third object plug-in window 243 includes a graphical representation of an activation property of the third asset 290. The value of the activation property of the third asset is graphically indicated by a color of the graphical representation of the activation property of the third asset 290. For example, the graphical representation of the activation property of the third asset 290 is white when the third asset is active and black when the third asset is inactive.

The third object plug-in window 243 indicates additional properties of the third asset (and their values) in selectable drop-down menus. For example, the third object plug-in window 243 includes a position drop-down menu 294A and a headlock drop-down menu 294B. Further drop-down menus may be accessed by manipulating the scroll bar 293.

In FIG. 2L, the position drop-down menu 294A is expanded within the third object plug-in window 243 to display representations of positional properties of the third asset and corresponding representations of values of the positional properties of the third asset. In particular, the third object plug-in window 243 includes an object plug-in textual representation of a coordinates property of the third asset 295A (e.g., the text “Coordinates”) and an object plug-in textual representation of a value of the coordinates property of the third asset 295B (e.g., the text “Spherical). The third object plug-in window 243 includes an object plug-in textual representation of a radius property of the third asset 296A (e.g., the text “Radius”) and an object plug-in textual representation of a value of the radius property of the third asset 296B (e.g., the text “3.7 m”). Between the object plug-in textual representation of the radius property of the third asset 296A and the object plug-in textual representation of the value of the radius property of the third asset 296B is an object plug-in graphical representation of the value of the radius property of the third asset in the form of a slider. The third object plug-in window 243 includes an object plug-in textual representation of an azimuth property of the third asset 297A (e.g., the text “Azimuth”) and an object plug-in textual representation of a value of the azimuth property of the third asset 297B (e.g., the text “−18°”). Between the object plug-in textual representation of the azimuth property of the third asset 297A and the object plug-in textual representation of the value of the azimuth property of the third asset 297B is an object plug-in graphical representation of the value of the azimuth property of the third asset in the form of a slider. The third object plug-in window 243 includes an object plug-in textual representation of an elevation property of the third asset 298A (e.g., the text “Elevation”) and an object plug-in textual representation of a value of the elevation property of the third asset 298B (e.g., the text “0°”). Between the object plug-in textual representation of the elevation property of the third asset 298A and the object plug-in textual representation of the value of the elevation property of the third asset 298B is an object plug-in graphical representation of the value of the elevation property of the third asset in the form of a slider. The third object plug-in window 243 includes an object plug-in textual representation of a directivity property of the third asset 299A (e.g., the text “Directivity”) and an object plug-in textual representation of a value of the directivity property of the third asset 299B (e.g., the text “Omnidirectional”).

In FIG. 2L, the cursor 299 is displayed over the third asset representation 261C in the spatial diagram 260 of the panner plug-in window 242.

FIG. 2M illustrates the GUI 201 of FIG. 2L in response to detecting activation of the third asset representation 261C. In response to detecting activation of the third asset representation 261C, the third asset is selected (and the first asset and second asset are unselected). Because the third asset is a single selected asset, the panner plug-in window 242 includes the object affordance 264C. In FIG. 2M, the object affordance 264C is selected and the panner plug-in window 242 displays representations of the properties of the third asset and representations of values of those properties in four drop-down menus, a position drop-down menu 301A, a headlock drop-down menu 301B, a rendering drop-down menu 301C, and a supplemental drop-down menu 301D.

In particular, within the position drop-down menu 301A, the panner plug-in window 242 includes a panner plug-in textual representation of the coordinates property of the third asset 302A (e.g., the text “Coordinates”) and a panner plug-in textual representation of the value of the coordinates property of the third asset 302B (e.g., the text “Spherical). The panner plug-in window 242 includes a panner plug-in textual representation of the radius property of the third asset 303A (e.g., the text “Radius”) and a panner plug-in textual representation of the value of the radius property of the third asset 303B (e.g., the text “3.7 m”). Between the panner plug-in textual representation of the radius property of the third asset 303A and the panner plug-in textual representation of the value of the radius property of the third asset 303B is a panner plug-in graphical representation of the value of the radius property of the second asset in the form of a slider. The panner plug-in window 242 includes a panner plug-in textual representation of the azimuth property of the third asset 304A (e.g., the text “Azimuth”) and a panner plug-in textual representation of the value of the azimuth property of the third asset 304B (e.g., the text “−18°”). Between the panner plug-in textual representation of the azimuth property of the third asset 304A and the panner plug-in textual representation of the value of the azimuth property of the third asset 304B is a panner plug-in graphical representation of the value of the azimuth property of the third asset in the form of a slider. The panner plug-in window 242 includes a panner plug-in textual representation of the elevation property of the third asset 305A (e.g., the text “Elevation”) and a panner plug-in textual representation of the value of the elevation property of the third asset 305B (e.g., the text “0°”). Between the panner plug-in textual representation of the elevation property of the third asset 305A and the panner plug-in textual representation of the value of the elevation property of the third asset 305B is a panner plug-in graphical representation of the value of the elevation property of the third asset in the form of a slider. The panner plug-in window 242 includes a panner plug-in textual representation of the directivity property of the third asset 306A (e.g., the text “Directivity”) and a panner plug-in textual representation of the value of the directivity property of the third asset 306B (e.g., the text “Omnidirectional”).

In FIG. 2M, the cursor 299 is displayed over the graphical representation of the value of the azimuth property of the third asset.

FIG. 2N illustrates the GUI 201 of FIG. 2M in response to detecting a user input changing the value of the azimuth property of the third asset. In various implementations, the user input includes dragging an element of the slider of the panner plug-in graphical representation of the azimuth property of the third asset from a first location to a second location. In various implementations, the user input includes activating the panner plug-in textual representation of the azimuth property of the third asset 304B and inputting a new value.

In response to detecting the user input, the value of the azimuth property of the third asset is changed and the panner plug-in textual representation of the value of the azimuth property of the third asset 304B is changed (e.g., to “−25°”). Similarly, the panner plug-in graphical representation of the azimuth property of the third asset is changed. Further, the third asset representation 261C in the spatial diagram 260 of the panner plug-in window 242 is moved to a new location within the spatial diagram 260. Because the changed value is written by the panner plug-in, using the dynamic library, to the portion of memory and the object plug-in, using the dynamic library, reads the portion of memory to determine the values of the properties, in the third object plug-in window 243, the object plug-in textual representation of the value of the azimuth property of the third asset 297B is changed (e.g., to the text “−25°”) and the corresponding graphical representation is similarly changed.

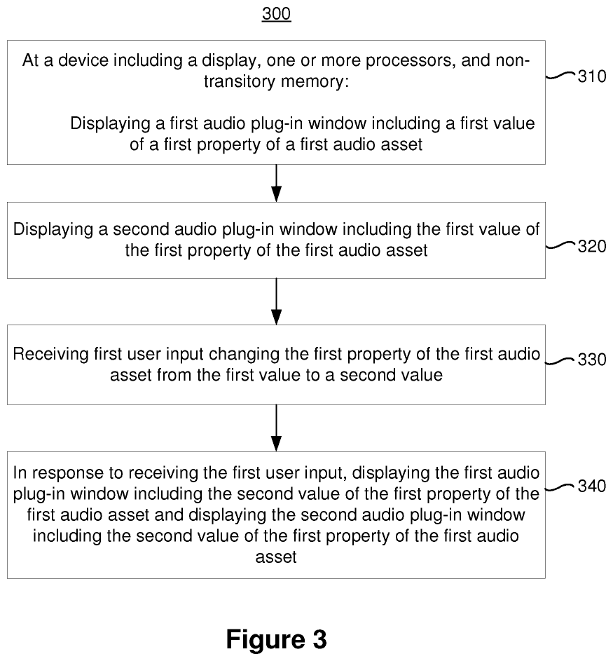

FIG. 3 is a flowchart representation of a method 300 of displaying a value of a property of an asset in accordance with some implementations. In various implementations, the method 300 is performed by a device with a display, one or more processors, and non-transitory memory. In some implementations, the method 300 is performed by processing logic, including hardware, firmware, software, or a combination thereof. In some implementations, the method 300 is performed by a processor executing instructions (e.g., code) stored in a non-transitory computer-readable medium (e.g., a memory).

The method 300 begins, in block 310, with the device displaying a first audio plug-in window including a first value of a first property of a first audio asset. For example, in FIG. 2E, the GUI 201 includes the second object plug-in window 241 including the object plug-in textual representation of the value of the radius property of the second asset 256B reading “3.0 m”.

The method 300 continues, in block 320, with the device displaying a second audio plug-in window including the first value of the first property of the first audio asset. For example, in FIG. 2E, the GUI 201 includes the panner plug-in window 242 including the panner plug-in textual representation of the value of the radius property of the second asset 282B reading “3.0 m”.

The method 300 continues, in block 330, with the device receiving first user input changing the first property of the first audio asset from the first value to a second value. For example, FIG. 2F illustrates the GUI 201 in response to a detecting a user input dragging the second asset representation 261B from a first location to a second location of the spatial diagram 260.

The method 300 continues, in block 340, with the device, in response to receiving the first user input, displaying the first audio plug-in window including the second value of the first property of the first asset and displaying the second audio plug-in window including the second value of the first property of the first asset. For example, in FIG. 2F, the GUI 201 includes the second object plug-in window 241 including the object plug-in textual representation of the value of the radius property of the second asset 256B reading “2.3 m” and the panner plug-in window 242 including the panner plug-in textual representation of the value of the radius property of the second asset 282B reading “2.3 m”.

In various implementations, the method 300 includes displaying a user interface of a digital audio workstation application including the first audio plug-in window and the second audio plug-in window. For example, in FIG. 2F, the GUI 201 is of a digital audio workstation (DAW) application. In various implementations, the first value of the first property of the first audio asset is stored in a portion of the non-transitory memory managed by a dynamic library. For example, the dynamic library may be a dynamic library loaded into a DAW process created by an operating system executing DAW software of the DAW application. In various implementations, the dynamic library is loaded by the DAW process in response to a request from a first audio plug-in (which defines the first audio plug-in window) or a second audio plug-in (which defined the second audio plug-in window). In various implementations, the method 300 includes, in response to receiving the user input, changing the first value to the second value in the portion of the non-transitory memory managed by dynamic library. In various implementations, changing the first value to the second value includes using the dynamic library to change the first value to the second value in the portion of the non-transitory memory.

In various implementations, a first audio plug-in defines display of the first audio plug-in window and a second audio plug-in defines display of the second audio plug-in window. In various implementations, the first audio plug-in and the second audio plug-in retrieve the first value and/or the second value from the portion of the non-transitory memory managed by the dynamic library. In various implementations, the first audio plug-in and the second audio plug-in retrieve the first value and/or the second value using the dynamic library.

In various implementations, displaying the second audio plug-in window includes displaying a first value of a first property of a second audio asset. For example, in FIG. 2E, the panner plug-in window 242 displays the panner plug-in textual representation of the value of the radius property of the second asset 282B, but in FIG. 2M, the panner plug-in window displays the panner plug-in textual representation of the value of the radius property of the third asset 303B. In various implementations, displaying the second audio plug-in window includes displaying a first value of a first property of a scene including the first audio asset. For example, in FIG. 2J, the panner plug-in window 242 displays the textual representation of the value of the height property of the scene 271B.

In various implementations, the first property of the first audio asset is a spatial property of the first audio asset. For example, in various implementations, the first property is a position and/or orientation of the object within a scene. In various implementations, the first property is a sound emission pattern or directivity. In various implementations, the first property of the first audio asset is an activation property of the first audio asset. For example, in various implementations, the value of the first property can indicate whether the first audio asset is “active” or “inactive”.

In various implementations, the first user input includes interaction with the first audio plug-in window. For example, in FIG. 2K, the value of the radius property of the second asset is changed based on interaction with the second object plug-in window 241. In various implementations, the first user input includes interaction with the second audio plug-in window. For example, in FIG. 2N, the value of the azimuth property of the third asset is changed based on interaction with the panner plug-in window 242.

Thus, in various implementations, when the first user input includes interaction with the second audio plug-in window, the method 300 further includes receiving second user input including interaction with the first audio plug-in window changing the first property of the first audio asset from the second value to a third value. In response to receiving the second user input, the method 300 includes displaying the first audio plug-in window including the third value of the first property of the first audio asset; and displaying the second audio plug-in window including the third value of the first property of the first audio asset. Thus, the value of the first property of the first audio asset can be changed via either plug-in window. In particular, the value of the first property of the first audio asset stored in the portion of the non-transitory memory managed by the dynamic library can be changed by either plug-in.

In various implementations, the method 300 includes receiving second user input changing a first property of a second audio asset from a third value to a fourth value. In response to receiving the second user input, the method 300 includes displaying the second audio plug-in window including the fourth value of first property of the second audio asset and displaying a third audio plug-in window including the fourth value of the first property of the second audio asset. For example, in FIG. 2F, the panner plug-in window 242 includes the panner plug-in textual representation of the value of the radius property of the second asset 282B reading “2.3 m”. However, in FIG. 2N, the panner plug-in window 242 includes the panner plug-in textual representation of the value of the radius property of the third asset reading “3.7 m”. Also in FIG. 2N, the third object plug-in window 243 includes the object plug-in textual representation of the value of the radius property of the third asset reading “3.7 m”.

In various implementations, the method 300 includes rendering one or more audio streams to produce an output audio stream based on the second value of the first property of the first audio asset. For example, in various implementations, the method 300 includes rendering an output audio stream including audio data of the first audio asset based on an activation property of the first audio asset (being set to “active”). As another example, in various implementations, the method 300 includes rendering to produce a binaural audio stream based on a position property of the first audio asset. As another example, in various implementations, the method 300 includes rendering to produce high-order ambisonics (HOA) audio based on a position property of the first audio asset. In various implementations, the input audio stream can include audio data associated with objects, channel beds (e.g., stereo, 5.1, etc.) or HOA. The output audio streams can be binaural, channel beds, or HOA.

In various implementations, rendering the one or more audio streams is further based on a first value of a first property of a second audio asset. For example, in various implementations, the method 300 includes rendering an audio stream including audio data of the first audio asset but not including audio data of the second audio asset based on an activation property of the second audio asset (being set to “inactive”). As another example, in various implementations, the method 300 includes rendering to produce a binaural audio stream based on different values of a position property of the first audio asset and the second audio asset.

In various implementations, rendering the one or more audio streams is further based on a first value of a first property of a scene including the first audio asset. For example, in various implementations, the method 300 includes rendering to produce HOA audio based on an absorption property and/or size property of the scene. As another example, in various implementations, the method 300 includes rendering to produce HOA audio based on a property of a listener of the scene, such as a position property and/or an orientation property.

In various implementations, rendering the one or more audio streams to produce an output audio stream is performed by a renderer plug-in. In various implementations, the one or more audio streams are provided to the renderer plug-in by the DAW process and the output audio stream is provided to the DAW process by the renderer plug-in. In contrast, values of various properties used by the renderer plug-in are retrieved, using the dynamic library, from the portion of the non-transitory memory. For example, when rendering the one or more audio streams based on the second value of the first property of the first audio asset, the renderer plug-in retrieves, using the dynamic library, the second value of the first property of the first audio asset from the portion of the non-transitory memory. Similarly, the renderer plug-in can retrieve, using the dynamic library, the first value of the first property of the second audio asset and/or the first value of the first property of the scene including the first audio asset from the portion of the non-transitory memory.

In various implementations, the renderer plug-in renders the one or more audio streams based on values of properties stored in the portion of the non-transitory memory that are not displayed in the first plug-in window or the second plug-in window. For example, in various implementations, the renderer plug-in renders the one or more audio streams based on the values of the properties when the first plug-in window and the second plug-in window have been closed. More generally, in various implementations, the renderer plug-in renders the one or more audio streams based on values of properties stored in the portion of the non-transitory memory that are not displayed at all, in any plug-in window or any other part of the user interface.

Thus, in various implementations, rendering the one or more audio streams is based on at least one value of a property that is not displayed. In particular, rendering the one or more audio streams is based on retrieving, from the portion of the non-transitory memory managed by the dynamic library, the at least one value of the property that is not displayed.

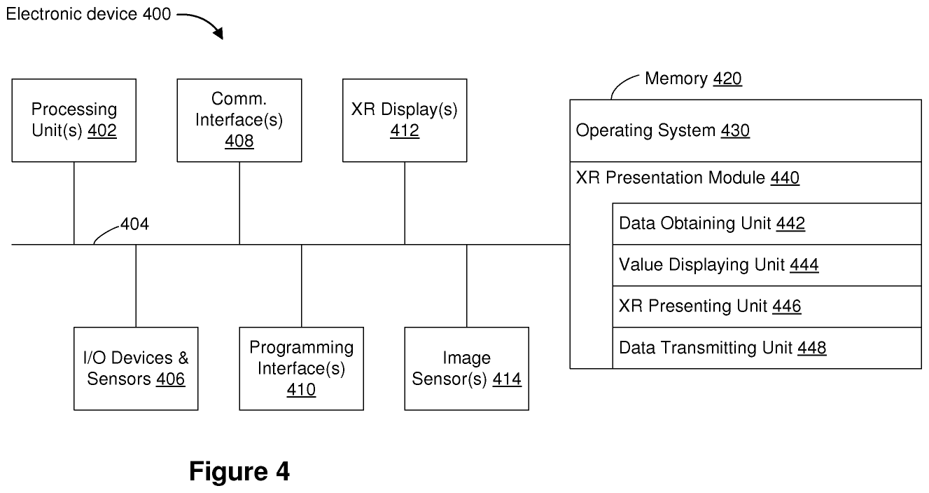

FIG. 4 is a block diagram of an electronic device 400 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 400 includes one or more processing units 402 (e.g., microprocessors, ASICs, FPGAs, GPUs, CPUs, processing cores, and/or the like), one or more input/output (I/O) devices and sensors 406, one or more communication interfaces 408 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 410, one or more XR displays 412, one or more optional interior-and/or exterior-facing image sensors 414, a memory 420, and one or more communication buses 404 for interconnecting these and various other components.

In some implementations, the one or more communication buses 404 include circuitry that interconnects and controls communications between system components. In some implementations, the one or more I/O devices and sensors 406 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 412 are configured to present XR content to the user. In some implementations, the one or more XR displays 412 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 412 correspond to diffractive, reflective, polarized, holographic, etc. waveguide displays. For example, the electronic device 400 includes a single XR display. In another example, the electronic device 400 includes an XR display for each eye of the user. In some implementations, the one or more XR displays 412 are capable of presenting AR, MR, and/or VR content.

In various implementations, the one or more XR displays 412 are video passthrough displays which display at least a portion of a real scene as an image captured by a scene camera. In various implementations, the one or more XR displays 412 are optical see-through displays which are at least partially transparent and pass light emitted by or reflected off the real scene.

In some implementations, the one or more image sensors 414 are configured to obtain image data that corresponds to at least a portion of the face of the user that includes the eyes of the user (any may be referred to as an eye-tracking camera). In some implementations, the one or more image sensors 414 are configured to be forward-facing so as to obtain image data that corresponds to the physical environment as would be viewed by the user if the electronic device 400 was not present (and may be referred to as a scene camera). The one or more optional image sensors 414 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 420 includes high-speed random-access memory, such as DRAM, SRAM, DDR RAM, or other random-access solid-state memory devices. In some implementations, the memory 420 includes non-volatile memory, such as one or more magnetic disk storage devices, optical disk storage devices, flash memory devices, or other non-volatile solid-state storage devices. The memory 420 optionally includes one or more storage devices remotely located from the one or more processing units 402. The memory 420 comprises a non-transitory computer readable storage medium. In some implementations, the memory 420 or the non-transitory computer readable storage medium of the memory 420 stores the following programs, modules and data structures, or a subset thereof including an optional operating system 430 and an XR presentation module 440.

The operating system 430 includes procedures for handling various basic system services and for performing hardware dependent tasks. In some implementations, the XR presentation module 440 is configured to present XR content to the user via the one or more XR displays 412. To that end, in various implementations, the XR presentation module 440 includes a data obtaining unit 442, a value displaying unit 444, an XR presenting unit 446, and a data transmitting unit 448.

In some implementations, the data obtaining unit 442 is configured to obtain data (e.g., presentation data, interaction data, sensor data, location data, etc.). The data may be obtained from the one or more processing units 402 or another electronic device. To that end, in various implementations, the data obtaining unit 442 includes instructions and/or logic therefor, and heuristics and metadata therefor.

In some implementations, the value displaying unit 444 is configured to display a user interface including the value of a property in at least two different windows. To that end, in various implementations, the value displaying unit 444 includes instructions and/or logic therefor, and heuristics and metadata therefor.

In some implementations, the XR presenting unit 446 is configured to present XR content via the one or more XR displays 412 and/or one or more speakers. To that end, in various implementations, the XR presenting unit 446 includes instructions and/or logic therefor, and heuristics and metadata therefor.

In some implementations, the data transmitting unit 448 is configured to transmit data (e.g., presentation data, location data, etc.) to the one or more processing units 402, the memory 420, or another electronic device. To that end, in various implementations, the data transmitting unit 448 includes instructions and/or logic therefor, and heuristics and metadata therefor.

Although the data obtaining unit 442, the value displaying unit 444, the XR presenting unit 446, and the data transmitting unit 448 are shown as residing on a single electronic device 400, it should be understood that in other implementations, any combination of the data obtaining unit 442, the value displaying unit 444, the XR presenting unit 446, and the data transmitting unit 448 may be located in separate computing devices.

Moreover, FIG. 4 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 4 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including non-transitory memory and one or more processors:
displaying a first audio plug-in window including a first value of a first property of a first audio asset;
displaying a second audio plug-in window including the first value of the first property of the first audio asset;
receiving first user input changing the first property of the first audio asset from the first value to a second value; and
in response to receiving the first user input,
displaying the first audio plug-in window including the second value of the first property of the first audio asset; and
displaying the second audio plug-in window including the second value of the first property of the first audio asset.

2. The method of claim 1, further comprising displaying a user interface of a digital audio workstation application including the first audio plug-in window and the second audio plug-in window.

3. The method of claim 1, wherein the first value of the first property of the first audio asset is stored in a portion of the non-transitory memory managed by a dynamic library.

4. The method of claim 3, further comprising, in response to receiving the first user input, changing the first value to the second value in the portion of the non-transitory memory managed by the dynamic library.

5. The method of claim 1, wherein displaying the second audio plug-in window includes displaying a first value of a first property of a second audio asset.

6. The method of claim 1, wherein displaying the second audio plug-in window includes displaying a first value of a first property of a scene including the first audio asset.

7. The method of claim 1, wherein the first property of the first audio asset is a spatial property of the first audio asset.

8. The method of claim 1, wherein the first property of the first audio asset is an activation property of the first audio asset.

9. The method of claim 1, wherein the first user input includes interaction with the first audio plug-in window.

10. The method of claim 1, wherein the first user input includes interaction with the second audio plug-in window.

11. The method of claim 10, further comprising:
receiving second user input including interaction with the first audio plug-in window changing the first property of the first audio asset from the second value to a third value;
in response to receiving the second user input,
displaying the first audio plug-in window including the third value of the first property of the first audio asset; and
displaying the second audio plug-in window including the third value of the first property of the first audio asset.

12. The method of claim 1, further comprising:
receiving second user input changing a first property of a second audio asset from a third value to a fourth value; and
in response to receiving the second user input,
displaying the second audio plug-in window including the fourth value of the first property of the second audio asset; and
displaying a third audio plug-in window including the fourth value of the first property of the second audio asset.

13. The method of claim 1, further comprising rendering one or more audio streams based on the second value of the first property of the first audio asset.

14. The method of claim 13, wherein rendering the one or more audio streams includes retrieving the second value of the first property of the first audio asset from a portion of the non-transitory memory managed by a dynamic library.

15. The method of claim 13, wherein rendering the one or more audio streams is further based on a first value of a first property of a second audio asset.

16. The method of claim 15, wherein rendering the one or more audio streams is further based on a first value of a first property of a scene including the first audio asset.

17. The method of claim 13, wherein rendering the one or more audio streams is based on at least one value of a property that is not displayed.

18. The method of claim 17, wherein rendering the one or more audio streams is based on retrieving, from the portion of the non-transitory memory managed by the dynamic library, the at least one value of the property that is not displayed.

19. A device comprising:
a display;
non-transitory memory; and
one or more processors to:
display a first audio plug-in window including a first value of a first property of a first audio asset;
display a second audio plug-in window including the first value of the first property of the first audio asset;
receive first user input changing the first property of the first audio asset from the first value to a second value; and
in response to receiving the first user input,
display the first audio plug-in window including the second value of the first property of the first audio asset; and
display the second audio plug-in window including the second value of the first property of the first audio asset.

20. A non-transitory memory storing one or more programs, which, when executed by one or more processors of a device including a display, cause the device to:
display a first audio plug-in window including a first value of a first property of a first audio asset;
display a second audio plug-in window including the first value of the first property of the first audio asset;
receive first user input changing the first property of the first audio asset from the first value to a second value; and
in response to receiving the first user input,
display the first audio plug-in window including the second value of the first property of the first audio asset; and
display the second audio plug-in window including the second value of the first property of the first audio asset.
